(19) United States
(12) Patent Application Publication
(10) Pub. No.: US 2003/0205424 A1
(43) Pub. Date: Nov. 6, 2003

(54) Skid steer loader

(75) Inventors: Brian E. Felsing, Park Ridge, IL (US); Anthony J. Lamela, Gilberts, IL (US); Troy D. Bateman, Joliet, IL (US)

Correspondence Address: INTELLECTUAL PROPERTY LAW DEPARTMENT CASE LLC, 700 STATE STREET, RACINE, WI, 53404, US

(73) Assignee: CASE CORPORATION, a Delaware Corporation

(21) Appl. No.: 10/136,129

(22) Filed: May 1, 2002

(51) Int. Cl. B60K 17/356

(52) U.S. Cl. 180/242

(57) ABSTRACT

A skid steer loader has a chassis having front and rear ends, and an engine mounted to the rear end of the chassis. There are four suspensions pivotally coupled to the chassis to pivot with respect to the chassis. Two of the suspensions are extended laterally outward from the left side of the chassis and the other two suspensions are extended laterally outward from the right side of the chassis. Wheels on the suspensions are driven by drive shafts extending from a longitudinal splitter box that, in turn, are coupled to two hydraulic motors.

### FIELD OF INVENTION

The invention relates generally to skid steer loaders and, more particularly, to a skid steer loader that incorporates a shock-absorbing device within a suspension system and reconfigures the skid steer loader's engine and its hydraulic drive system.

### BACKGROUND OF THE INVENTION

Skid Steer Loaders (SSLs) are compact and highly maneuverable vehicles, which include work implements capable of being moved through a number of positions during a work cycle. The work implements include buckets, forks, and other material handling apparatus. The bucket is fixed on the end of the SSL arm and could be raised, lowered, filled, and emptied by tilting. The SSL is typically a small vehicle on the order of 10 to 14 feet long that rests on four or more wheels, two disposed on each side of the vehicle. This vehicle is able to fit in relatively confined spaces. SSLs are propelled and maneuvered by driving the wheels on one side of the vehicle at a different speed or in a different direction from those on the other side of the vehicle so as to achieve a turning motion. If the wheels were driven at the same speed but in opposite directions, the skid steer loader would appear to rotate about a center point in the vehicle, in other words, spin in its own tracks. This ability to change direction by rotation about an axis within the footprint or perimeter of the loader itself was the primary reason why the skid steer loader achieved its great success.

The SSLs generally do not include hydraulic shock-absorbing devices within the suspension system. Therefore, as the loader is travelling, the forces exerted on the loader by the terrain cause the loader to bounce and/or to vibrate which results in considerable operator discomfort and increased wear on the vehicle.

In an effort to reduce the effect of these forces, prior art suggests adding a hydraulic accumulator to the lift cylinder. This arrangement allows hydraulic fluid to flow from the head end of the lift cylinder to an accumulator and from the rod end of the lift cylinder to fluid reservoir.

However, connecting the hydraulic accumulator to the lift cylinder does not isolate bouncing and/or vibration of SSL from the operator but counter-reacts the bounce to reduce the magnitude of harmonic bounces.

Therefore, the need has arisen to improve the design of SSL that eliminates the bouncing and vibration of the work vehicle before it reaches the operator. The improved design of SSL also overcomes the operator discomfort during operation of the loader and reduces wear on the SSL.

### SUMMARY OF THE INVENTION

The present invention relates to a skid steer loader (SSL) including an improved suspension system that has a shock-absorbing device. In addition to the improved suspension system, the hydraulic drive system and the engine are also reconfigured to overcome the operator discomfort during operation of the SSL, and to reduce wear on the work vehicle.

In accordance with a first embodiment of the invention, a skid steer loader has a chassis, and an engine mounted on the chassis. There are four suspensions pivotally coupled to the chassis to pivot with respect to the chassis. Two of the suspensions are extended laterally outward from the left side of the chassis and the other two suspensions are extended laterally outward from the right side of the chassis. Each suspension also includes a control arm, a wheel, a drive shaft support, and a shock-absorbing device, which are all interconnected to one another. The control arm has a first end and a second end. The first end is pivotally coupled to the chassis to pivot about a generally longitudinal and horizontal axis. The drive shaft support is pivotally coupled to the second end of the control arm to translate vertically with respect to the chassis. The wheel is coupled to the drive shaft support to rotate with respect thereto. The shock absorbing device is coupled to and between the drive shaft support and the chassis.

A longitudinally extending splitter box having left and right laterally opposed and longitudinally extending sides, comprises a longitudinally extending housing that has laterally opposed left and right sides. There are four drive shafts extending outward from the housing and drivingly coupled to the four suspensions. Two of the drive shafts extend from each of the left and right sides of the housing. Each drive shaft has a first end and a second end. The first end of the each drive shaft is disposed in the housing and the second end extends out of the housing and is coupled to one of the four wheels to rotate the wheel.

First and second hydraulic motors are coupled to the left and right sides of the housing, respectively. First and second hydraulic pumps are rotationally coupled to the engine. The first and second hydraulic motors are hydraulically coupled to the first and second hydraulic pumps. The first hydraulic motor has a first motor output shaft that is disposed inside the housing and is drivingly engaged to the two drive shafts extending from the left side of the housing. The second hydraulic motor has a second output shaft that is disposed inside the housing and is drivingly engaged to the two drive shafts extending from the right side of the housing.

In accordance with a second embodiment of the invention, a work vehicle has a chassis having front and rear ends, and an engine mounted to the rear end of the chassis. There are four suspensions pivotally coupled to the chassis to pivot with respect to the chassis. Two of the suspensions are extended laterally outward from the left side of the chassis and the other two suspensions are extended laterally outward from the right side of the chassis. Each suspension also includes a control arm, a drive shaft support, a wheel, and a shock absorbing device, which are all interconnected to one another. The control arm has a first end and a second end. The first end is pivotally coupled to the chassis to pivot about a generally longitudinal and horizontal axis. The drive shaft support is pivotally coupled to the second end of the control arms to translate vertically with respect to the chassis. The wheel is coupled to the drive shaft support to rotate with respect thereto. The shock absorbing device is coupled to and between the drive shaft support and the chassis. There are four coil springs, which each of the coil springs is coupled to one of the four suspensions to support the one suspension with respect to the chassis.

A longitudinally extending splitter box having left and right laterally opposed and longitudinally extending sides, comprises a longitudinally extending housing that has laterally opposed left and right sides drivingly coupled to the four suspensions. There are four drive shafts in which two of the drive shafts are extending from each of the left and right sides of the housing. Each drive shaft has a first end and a second end. The first end of the each drive shaft is disposed in the housing and the second end extends out of the housing and is coupled to one of the four wheels to rotate the wheel.

First and second hydraulic motors are coupled to the left and right sides of the housing, respectively. First and second hydraulic pumps are rotationally coupled to the engine. The first and second hydraulic motors are hydraulically coupled to the first and second hydraulic pumps. The first hydraulic motor has a first motor output shaft that is disposed inside the housing and is drivingly engaged to the two drive shafts extending from the left side of the housing. The second hydraulic motor has a second output shaft that is disposed inside the housing and is drivingly engaged to the two drive shafts extending from the right side of the housing.

### BRIEF DESCRIPTION OF THE DRAWINGS

The drawings illustrate the best mode presently contemplated for carrying out the invention.

FIG. 1 is a side elevation view of a Skid Steer Loader (SSL) incorporating the present invention;

FIG. 2 is a top plan view of the SSL in FIG. 1 taken along line 2-2 showing the way in which the suspension system, the hydraulic drive system, and the engine are arranged with respect to one another;

FIG. 3 is a side elevation, partially in section, of a portion of FIG. 2 taken along line 3-3;

FIG. 4 is a top view of a portion of FIG. 3 taken along line 4-4;

FIG. 5 is a side elevation, partially in section, of a portion of FIG. 2 taking along line 5-5;

FIG. 6 is a side elevation, partially in section, of a portion of FIG. 2 taking along line 6-6; and

FIG. 7 is a top plan view of a second embodiment of the invention identical to FIG. 2 in which the four coil springs are replaced with four torsion bars.

### DETAILED DESCRIPTION OF PREFERRED EMBODIMENTS

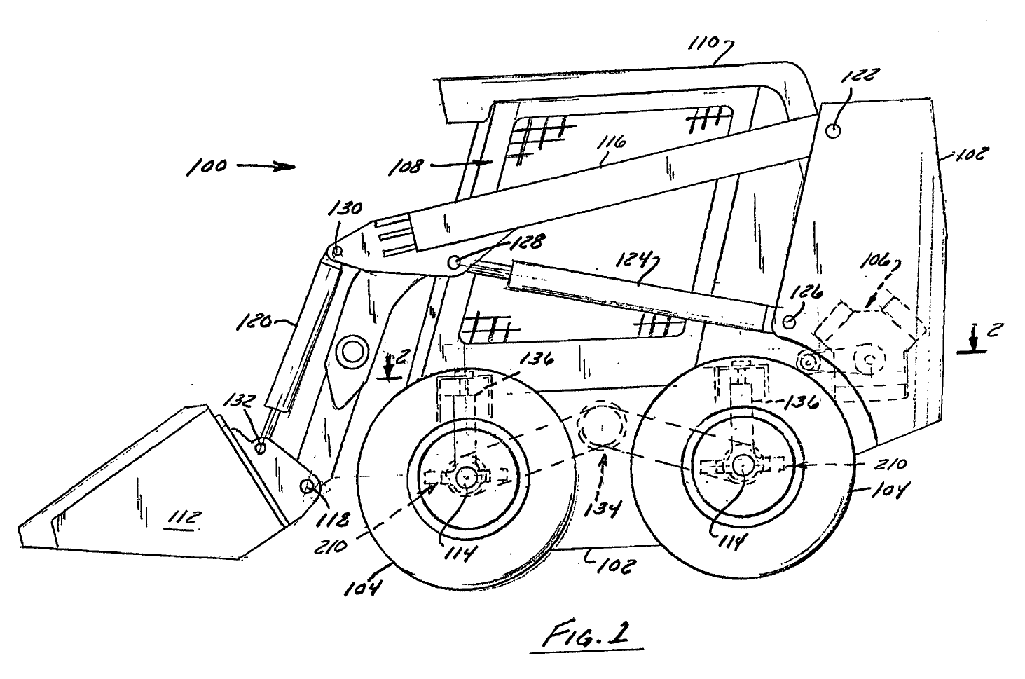

FIG. 1 shows a side elevation view of a Skid Steer Loader (SSL) 100 constructed in accordance with the present invention. The SSL 100 includes a chassis 102 to which four wheels 104 are connected, two on each side. In this view, only two of the four wheels 104 are shown. There are two wheels in identical positions on the other side of the SSL 100. The four wheels have the same diameter. Wheels 104 are mounted on drive shafts 114 projecting outwardly from the opposite sides of the chassis 102. A pair of loader arms 116 overlies the wheels on each side of the SSL and extends forward alongside an operator's compartment 108 and project arcuately downward at the front of the SSL to overlie the front of the wheels 104. An operator's compartment 108 is configured above and between the wheels.

A bucket 112 is mounted at the forward end of the loader arms and is pivotally coupled to the loader arms 116 at the pivot joint 118. The bucket 112 pivots about a substantially horizontal axis with respect to the loader arm 116 when bucket cylinder 120 is retracted or extended. The operator's compartment 108 is enclosed by an overhead guard 110 providing protection against objects falling on to the compartment area 108 from above, such as material spilling over the rear of the bucket 112 when in a raised position. The overhead guard 110 also serves as a rollover protective structure.

The loader arms 116 are pivotally coupled to the chassis 102 at pivot joint 122 such that the loader arms 116 raise and lower whenever a lift cylinder 124 extends and retracts, respectively. The bucket cylinder 120 is pivotally coupled both to the loader arms 116 and the bucket 112 at the pivot joint 130 and 132, respectively. The lift cylinder 124 is pivotally coupled to the loader arms 116 and to the chassis 102 at the pivot joints 126 and 128, respectively. By means of the joysticks and foot pedals (not shown) located in the operator's compartment 108, the operator is able to control independently the extension and retraction of the bucket and lift cylinders 120, 124 when working the SSL.

Still referring to FIG. 1, an engine 106 is mounted at the rear end of chassis 102 and a hydraulic drive system 134 is mounted in the central portion of the chassis 102. A pair of shock absorbing devices 136 is coupled to the chassis 102 to reduce bouncing and vibration of the SSL during operation. All functions of the SSL can be controlled by the operator from within the operator's compartment 108. The hydraulic drive system 134, which will be described in detail in a subsequent portion of this specification, is actuated by using the joysticks.

The SSL turns by driving the wheels on one side at a different speed and/or direction than those on the other side, causing the SSL 100 to have great mobility in maneuvering in either the forward or reverse direction. The steering mechanism is controlled by the operator using the joysticks, which may be moved independently in a fore and aft direction to cause the wheels on that side of the SSL to rotate at a speed and in a direction corresponding to the direction of the joysticks. For example, if the joysticks moved together in either forward or rearward manner, it will cause the work vehicle to travel straight forward or back up at variable speeds depending on the position of the joystick. If the operator moves the joysticks simultaneously but to a greater degree on one side than the other, it will cause the SSL to execute a turn. Finally, by pushing one joystick in one direction and pulling the other in the opposite direction, the SSL is turned on its axis and spins around in its own tracks.

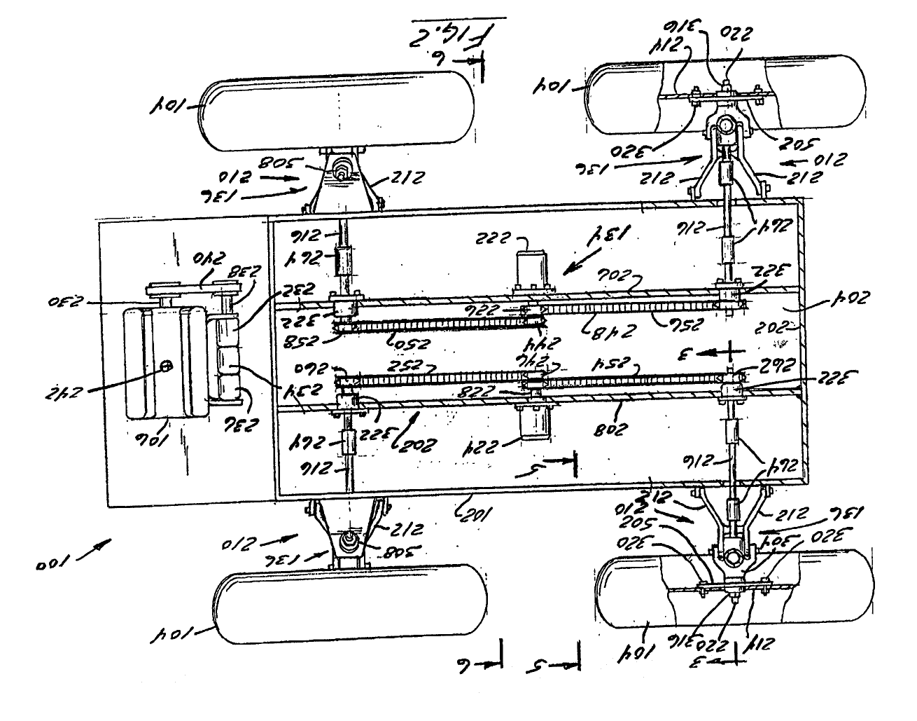

FIG. 2 is a lower portion of a top view of the SSL 100 in FIG. 1 showing the way in which the individual suspensions, the hydraulic drive system, and the engine are arranged with respect to one another. A longitudinally extending splitter box 202 having left and right laterally opposed and longitudinally extending sides, comprises a longitudinally extending housing 204 that is drivingly coupled to four suspensions 210. The housing 204 has laterally opposed left and right sides 206, 208, respectively.

Two of the four suspensions 210 are pivotally coupled in the front end of the chassis 102 and, the other two suspensions 210 are pivotally coupled in the rear end of the chassis. In other words, two suspensions are extended laterally outward from the left side of chassis 102 and the other two suspensions are extended laterally outward from the right side of the chassis 102. The four suspensions 210, two in the front end of the chassis and two in the rear end of the chassis are identical, independent, and mirror image of one another. For purpose of clarity in FIG. 2, the two suspensions at the rear end of the chassis 102 are not detailed. However, they are constructed and operate identically the same as the front suspensions described herein.

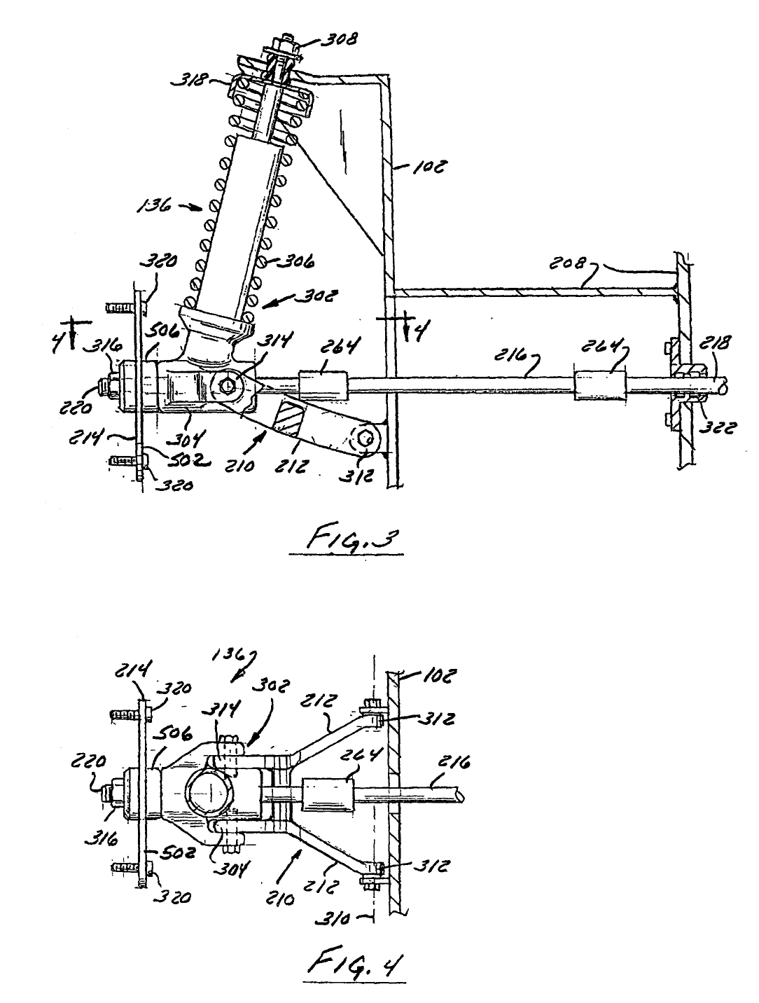

Each of the suspensions 210 includes a control arm 212 and a drive shaft support 304 (shown in FIG. 3) that are coupled to one another in the front and the rear ends of the chassis 102. Each wheel 104 is coupled to a wheel hub 214 to rotate with respect to the drive shaft support 304.

There are four drive shafts 216, of which two of the drive shafts 216 extend from left side 206 of the housing and the other two drive shafts 216 extend from the right side 208 of the housing. Each of the drive shafts 216 on the left side 206 of the housing has a first end 218 and a second end 220, as best shown in FIG. 3. The first end 218 of the each drive shafts is disposed in the housing 204 and the second end 220 of the each drive shaft is coupled to one of the four wheels 104 to rotate the wheel. Each drive shaft 216 comprises a pair of constant velocity joints 264 disposed between the drive shaft support 304 and the housing 204. The two drive shafts 216 on the right side are identical to the two drive shafts in the left side and utilized in the same manner.

Still referring to FIG. 2, first and second hydraulic motors 222, 224 are mounted on central portion of the housing 204. The first hydraulic motor 222 is coupled to the left side 206 of the housing and the second hydraulic motor 224 is coupled to the right side 208 of the housing. The first and second hydraulic motors 222, 224 further include first and second motor drive shafts 226, 228, respectively, which are disposed inside the housing 204. The first motor drive shaft 226 is drivingly engaged to the two drive shafts 216 that are extending from the left side 206 of the housing. The second motor drive shaft 228 is drivingly engaged to the two drive shafts 216 that are extending from the right side 208 of the housing. The first and second hydraulic motors 222, 224 carry drive sprockets 244 and 246, respectively, at an inner end of the drive shafts 226, 228. The drive sprockets 244, 246 comprise portions of the hydraulic drive system 134 (also shown in FIG. 1) provided for each set of wheels 104 located on left and right sides of the housing 204, respectively. Endless chains 248, 250 on the left side of the housing 204 connect drive sprocket 244 to the driven sprockets 256 and 258. Similarly, endless chains 252, 254 on the right side of the housing 204 connect drive sprocket 246 to the driven sprockets 260 and 262. The hydraulic motors 222, 224 are mounted between the driven sprockets, i.e. to the rear of the forward driven sprockets and forward of the rear driven sprockets. The hydraulic motors on left and right sides of the housing transmit rotational motion to their corresponding drive shafts on left and right sides and, in turn, rotate the wheels on that side in both forward and reverse directions as selected by the operator using the joysticks. This design configuration allows the wheels on one side to rotate at a different speed and/or direction than those on the other side.

Engine 106 is preferably an internal combustion engine and is preferably configured such that its crankshaft 230 extends laterally with respect to the lateral extend of the chassis 102. The engine is preferably disposed in a side-to-side orientation with respect to the chassis. Three hydraulic pumps 232, 234, and 236 are rotationally coupled to the engine 106 to be driven thereby. The three hydraulic pumps are preferably connected in series and include shafts 238 that rotate about a common axis. The first and second pumps 232 and 234 are hydraulically coupled to the first and second hydraulic motors 222, 224, respectively; to supply pressurized hydraulic fluid to the hydraulic motors. The third hydraulic pump 236 is provided as a source of pressurized hydraulic fluid that is applied to the lift cylinders 124 and bucket cylinders 120. The pump shafts 238 are rotationally coupled to the crankshaft 230 through a belt 240. The pump shafts 238 and the crankshaft 230 preferably rotate about a parallel axes of rotation. To provide the compact wheelbase and the stability of the SSL, the center of gravity 242 of the engine 106 is disposed adjacent to and behind the rear wheels of the loader.

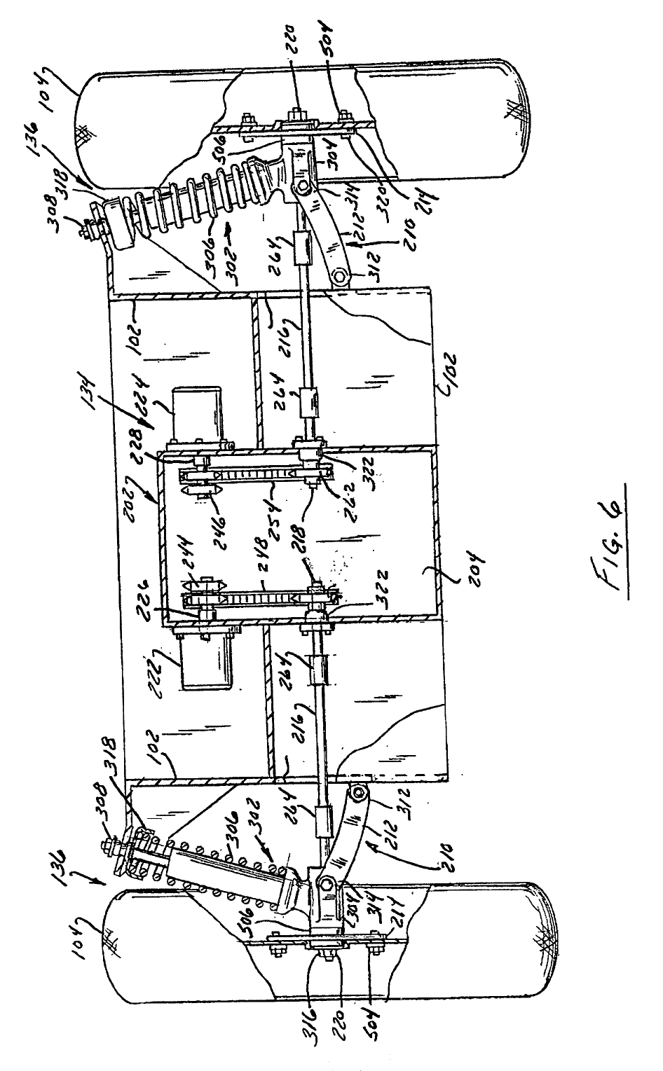

Referring now to FIGS. 3, 4 and 5, the shock absorbing device 302 is coupled both to drive shaft support 304 and to the chassis 102. It is connected to chassis 102 by nut 308. The drive shaft support 304 includes a pair of bearings 322 that supports the second end 220 of the drive shaft 216 as best shown in FIG. 5. The first end of the drive shaft is supported by another bearing 322 that is mounted on the right side 208 of the housing. The second end of the drive shaft is coupled to the wheel hub 214 by nut 316. The shock absorbing device 302 is positioned within a coil spring 306. There are four coil springs 306, which each of the four coil springs is coupled to one of the four suspensions 210 to support the one suspension 210 with respect to the chassis 102. The coil spring 306 is secured at the lower end to the drive shaft support 304 and at the upper end to the nut 308 through a spring retainer 318. The shock absorbing device 302 is of a type employed in automobile and truck suspensions to dampen the oscillation of a vehicle, and is well known in the art and will not be further discussed. A flange 502 having a flange neck 506, which is fixed to the wheel hub 214 to provide mounting surface against which wheels 104 can be mounted. Several bolts 320 extend outward from the flange 502 to receive mating holes on wheel 104 as best shown in FIG. 5. Once bolts 320 are inserted through these holes, nuts 504 are threaded on the free end of the bolts to prevent the wheel from coming off the drive shaft support. As the SSL is travelling, the shock absorbing device absorbs the forces exerted on the SSL by the terrain and that reduces the bouncing and/or vibration of the work vehicle. The shock absorbing device eliminates the considerable operator discomfort and reduces wear on the vehicle. The construction, arrangement and operation of the left front suspension in FIGS. 3-5 is the same as the right front suspension, but is a mirror image thereof.

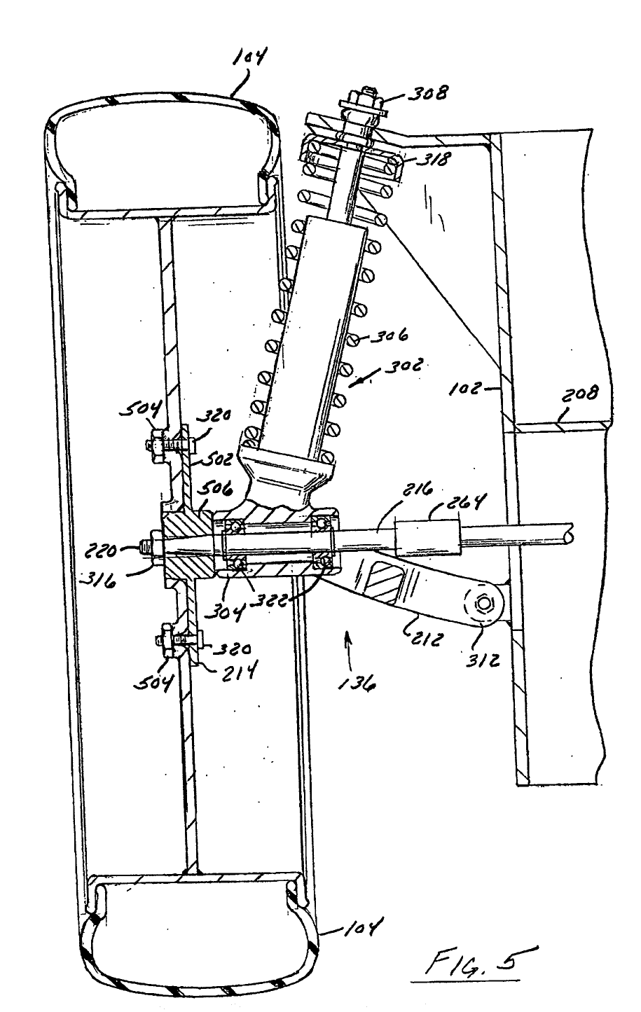

As mentioned above, the control arm 212 has a first end 312 and a second end 314. The first end 312 is pivotally coupled to the chassis 102 to pivot about a generally longitudinal and horizontally extending axis 310 as best depicted in FIG. 4. The second end 314 of the control arm 212 is pivotally coupled to the drive shaft support 304 to translate vertical motion with respect to the chassis. Each of the drive shafts also includes a pair of constant velocity joints 264 that permit the point of contact between the two halves of the drive shaft to remain in a plane which bisects the angle between the two halves of the drive shafts.

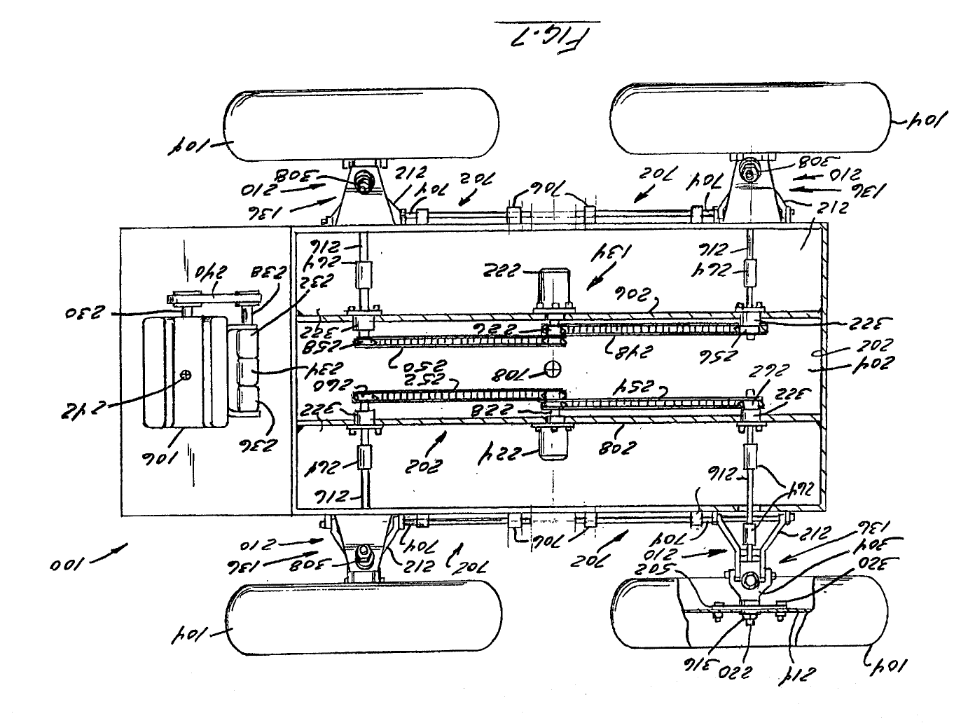

FIG. 6 is a side elevation, partially in section, of a portion of FIG. 2. The suspensions shown in this view are the front left and the front right suspensions 210. These suspensions are identically configured and are mirror images of one another. The two drive shafts 216 extending from each of the left and right sides of portion of the housing are co-axial. These drive shafts rotate on a common axis. The relative position and elevation of two hydraulic motors 222, 224 with respect to one another are clearly illustrated. For example, hydraulic motor 222 is engaged with the drive shafts 216 disposed on the left side of the housing, and allows the wheels on the left side of the vehicle to be simultaneously rotated at the same speed by hydraulic motor 222 independent of the wheels on the right side of the vehicle. The other hydraulic motor 224 is similarly connected to and drives the wheels on the right side of the vehicle.

FIG. 7 illustrates a second embodiment of the invention that is identical to the embodiment shown in FIGS. 1-6 and described above with one difference: coil spring 306 has been replaced with torsion spring 702, here shown as a torsion bar. The torsion bar 702 includes a first end 704 and a second end 706. The first end 704 is fixed to the control arm 212 and the second end 706 is anchored to the chassis 102. The torsion bar 702 is an alternative spring that uses the flexibility of a steel bar or tube twisting lengthwise to provide spring action. Instead of the compressing and extending action of the coil spring, the torsion bar twists to exert resistance against up and down movement. In the embodiment of FIG. 7, the torsion bars are mounted lengthwise having the first end 704 of the torsion bars fixed to the control arms 212 and the second end 706 anchored to the vehicle chassis 102. With each rise and fall of a front wheel 104, the control arm 212 pivots up and down, twisting the torsion bar 702 along its length to absorb road shock and cushion the ride.

The torsion bar 702 is disposed parallel to the longitudinal extend of the chassis. The first end 704 of each torsion bar pivots with respect to the chassis as the control arm 212 twists the torsion bar 702.

To enhance the stability of the loader, each of the torsion bars for the front suspensions extend backward towards the center of gravity 708 of the loader. Similarly, each of the torsion bars for the rear suspensions extend forward towards the center of gravity 708 of the loader.

While the embodiments illustrated in the FIGURES and described above are presently preferred, it should be understood that these embodiments are offered by way of example only. The invention is not intended to be limited to any particular embodiment, but is intended to extend to various modifications that nevertheless fall within the scope of the appended claims.

What is claimed is:

1. A skid steer loader comprising:
a chassis;
an engine mounted to the chassis;
first and second hydraulic pumps rotationally coupled to the engine to be driven thereby;
four suspensions pivotally coupled to the chassis to pivot with respect thereto wherein two suspensions extend laterally outward from a left side of the chassis and two suspensions extend laterally outward from a right side of the chassis and further wherein each of the suspensions includes:
a control arm having first and second ends, wherein the first end is pivotally coupled to the chassis to pivot about a generally longitudinal and horizontally extending axis;
a drive shaft support pivotally coupled to the second end of the control arms to translate vertically with respect to the chassis;
a wheel coupled to the drive shaft support to rotate with respect thereto; and
a shock absorbing device coupled to and between the drive shaft support and the chassis;
a longitudinally extending splitter box having left and right laterally opposed and longitudinally extending sides drivingly coupled to the four suspensions wherein the splitter box includes a longitudinally extending housing having laterally opposed left and right sides;
four drive shafts, two extending from each of the left and right sides of the housing and having first and second ends, wherein the first end of the each drive shaft is disposed in the housing and wherein the second end of the each drive shaft extends out of the housing and is coupled to one of the four wheels to rotate the wheel;
a first hydraulic motor coupled to the left side of the housing and having a first motor output shaft disposed inside the housing, wherein the first motor output shaft is drivingly engaged to the two drive shafts extending from the left side of the housing, and further wherein the first hydraulic motor is hydraulically coupled to the first hydraulic pump to be driven thereby; and
a second hydraulic motor coupled to the right side of the housing and having a second motor output shaft disposed inside the housing, wherein the second motor output shaft is drivingly engaged to the two drive shafts extending from the right side of the housing, and further wherein the second hydraulic motor is hydraulically coupled to the second hydraulic pump to be driven thereby.

2. The skid steer loader of claim 1 further comprising a coil spring coupled to the shock absorber to support the chassis above the ground.

3. The skid steer loader of claim 1, wherein the engine is disposed in a side-to-side orientation with respect to the chassis.

4. The skid steer loader of claim 1 further comprising an operator's compartment configured above and between the wheels.

5. The skid steer loader of claim 1, wherein the engine is disposed behind the operator's compartment.

6. The skid steer loader of claim 1, wherein the four suspensions are independent from one another.

7. The skid steer loader of claim 1, wherein the first and second hydraulic pumps are disposed in front of the engine.

8. The skid steer loader of claim 1, wherein the rear wheels have the same diameter.

9. The skid steer loader of claim 1 further comprising a pair of constant velocity joints coupled to each of the drive shaft and wherein the constant velocity joints are disposed between the wheel hub and the housing.

10. The skid steer loader of claim 1 further comprising a drive sprocket mounted on each of the motor output shafts and a driven sprocket mounted on the first end of each drive shaft.

11. The skid steer loader of claim 10, wherein the drive sprocket is coupled to the driven sprocket by an endless chain.

12. The skid steer loader of claim 1, wherein the first and second hydraulic motors are mounted between their driven sprockets.

13. A work vehicle comprising:
a chassis having front and rear ends;
an engine mounted to the rear end of the chassis and wherein the engine is disposed in a side-to-side orientation with respect to the chassis;
first and second hydraulic pumps rotationally coupled to the engine to be driven thereby;
four suspensions pivotally coupled to the chassis to pivot with respect thereto wherein two suspensions extend laterally outward from a left side of the chassis and two extend laterally outward from a right side of the chassis and further wherein each of the suspensions includes:
a control arm having first and second ends, wherein the first end is pivotally coupled to the chassis to pivot about a generally longitudinal and horizontally extending axis;
a drive shaft support pivotally coupled to the second end of the control arms to translate vertically with respect to the chassis;
a wheel coupled to the drive shaft support to rotate with respect thereto; and
a shock absorbing device coupled to and between the drive shaft support and the chassis;
four coil springs, each of the four coil springs coupled to one of the four suspensions to support the one suspension with respect to the chassis;
a longitudinally extending splitter box having left and right laterally opposed and longitudinally extending sides drivingly coupled to the four suspensions wherein the splitter box includes a longitudinally extending housing having laterally opposed left and right sides;
four drive shafts, two extending from each of the left and right sides of the housing and having first and second ends, wherein the first end of the each drive shaft is disposed in the housing and wherein the second end extends out of the housing and is coupled to one of the four wheels to rotate the wheel;
a first hydraulic motor coupled to the left side of the housing and having a first motor output shaft disposed inside the housing, wherein the first motor output shaft is drivingly engaged to the two drive shafts extending from the left side of the housing, and further wherein the first hydraulic motor is hydraulically coupled to the first hydraulic pump to be driven thereby; and
a second hydraulic motor coupled to the right side of the housing and having a second motor output shaft disposed inside the housing, wherein the second motor output shaft is drivingly engaged to the two drive shafts extending from the right side of the housing, and further wherein the second hydraulic motor is hydraulically coupled to the second hydraulic pump to be driven thereby.

14. The work vehicle of claim 13 further comprising an operator's compartment configured above and between the wheels.

15. The work vehicle of claim 13, wherein the first and second hydraulic motors are mounted between the driven sprockets and wherein the first and second hydraulic motor causes the wheels to rotate independently from one another.

16. The work vehicle of claim 13, wherein the first and second hydraulic pumps supply pressurized hydraulic fluid to first and second hydraulic motors independently from one another.

17. The skid steer loader of claim 13, wherein the rear wheels have the same diameter.

18. The skid steer loader of claim 13 further comprising a pair of constant velocity joints coupled to each of the drive shaft and wherein the constant velocity joints are disposed between the wheel hub and the housing.

19. The skid steer loader of claim 13 further comprising a drive sprocket mounted on each of the motor output shaft and a driven sprocket mounted on the first end of each drive shaft.

20. The skid steer loader of claim 13, wherein the drive sprocket is coupled to the driven sprocket by an endless chain.
